(19) United States
(12) Patent Application Publication
(10) Pub. No.: US 2018/0329235 A1
(43) Pub. Date: Nov. 15, 2018

(54) DUAL-LOOP SELF-INJECTION LOCKED OPTOELECTRONIC OSCILLATOR

(71) Applicant: Alexander Vikulin, Bradenton, FL (US)

(72) Inventor: Alexander Vikulin, Bradenton, FL (US)

(21) Appl. No.: 15/977,898

(22) Filed: May 11, 2018

Related U.S. Application Data
(60) Provisional application No. 62/505,518, filed on May 12, 2017.

(51) Int. Cl. G02F 1/01

(52) U.S. Cl. CPC G02F 1/0123; G02F 2001/212

(57) ABSTRACT

The present disclosure provides a dual loop self injection locked optoelectronic oscillator having a single fiber in its both loops which generates a high Q microwave output signal with a very low phase noise and spurious harmonics levels. The circuit may comprise an optical coupler having different lengths of the output arms and two electronic paths, which form two feedback loops of the oscillator. The circuit may comprise a single fiber with high Q, an optical circulator, and an optical coupler, which serves as a reflector, and two electronic paths which form two feedback loops of the oscillator.

### CROSS-REFERENCE TO RELATED APPLICATIONS

This application incorporates by reference and claims the benefit of priority to U.S. Provisional Application 62/505,518 filed on May 12, 2017.

### BACKGROUND OF THE INVENTION

The present subject matter relates generally to photonic and optoelectronic oscillators of improved performance providing high RF frequency stability and ultralow levels of phase noise.

A variety of approaches can be used to obtain high spectral purity and low noise signals. For example, radio frequency (RF) and microwave oscillating signals may be generated by using various types of oscillators having energy storage elements. The quality factor Q, or the energy storage time, of an energy storage element inside an oscillator can determine the spectral linewidth of the respective oscillating signal. High quality factor Q or long energy storage time can be used to reduce the spectral linewidth of the oscillating signal and hence improve the signal spectral purity. The described approach exploits a “hybrid” technology by using both electronic and optical active and passive components to form opto-electronic oscillators (OEOs). OEOs typically use a laser source of optical emission and optical modulation to produce electrical output oscillations at microwave frequencies that can exhibit narrow spectral line widths and ultra low phase noise in comparison with the conventional RF and microwave signal sources.

The generation of RF and microwave signals using optical and photonics techniques has a history of research and development [1,2]. The OEO design, introduced by Yao and Maleki, exploits optical fibers of different lengths as the high Q element [3]. OEOs have attracted great attention due to their extraordinary spectral purity. A number of different types of OED's have been demonstrated successfully such as the coupled optoelectronic oscillator [4], multi loop OEO architectures [5], and OEO with photonic filters that use atomic cells [6]. The conventional OEO consists of a seed laser source followed by a modulator. After passing through an optical delay line, the modulated signal is detected, amplified by an RF amplifier, filtered by a narrow band bandpass RF filter. The filtered signal is then split into two portions, one of which is sent back to the modulator to complete the loop, and the other is the output of the oscillator. To have a low level of phase noise it is important ensure low noise of all active components, including lasers, photodetectors, and amplifiers [7].

The noise performance of the OEO is determined by several factors, such as diode laser bias current and temperature, the relative intensity noise of the laser, lengths of a single or multiple fibers (see below), the operating condition of an optical Mach-Zehnder modulator, the bandwidths of an RF filter used for narrowband filtering of the oscillating signal. Phase noise reduction is accomplished in several ways, including multiple lengths of optical delay lines and custom optical receivers to provide multiple electrical references for self-injection locking (IL), self-phase locked looping (PLL), and/or self-mode locking (ML) functions in a closed loop part. These components can contribute to a low noise stable RF oscillator configuration that supports self-sustained oscillations, provided that the electrical feedback signal fed to the modulator meets certain oscillation conditions in terms of its amplitude and phase.

However, there are some drawbacks of the standard OEOs developed in early years. First, a high gain and low noise RF amplifier is needed in order to compensate the losses in both optical and electrical parts of the loop. For vast majority cases the gain must be over 40-50 dB and tow RF amplifiers are required. Second, it is costly to make an ultra narrow bandwidth RF filter which is required when the optical delay line (the fiber length) is long. Indeed, target levels of the phase noise below −100 dBc/Hz, require fibers longer than a few kilometres. The output signal from the OEO includes not only the primary frequency, but also harmonics at evenly spaced intervals. The frequency spacing Df of the harmonics is approximately equal to:

Δf=c/(nL) (1)

wherein c is the speed of light, n is the index of refraction of the optical fiber, and L equals the length of the optical fiber. For a few kilometre long fibers Df is in a few dozens of kHz range. This implies a very narrow bandwidth of the RF filter. And third, the additional loss from the RF filter decreases the cavity Q of the optoelectronic oscillator, which results in an additional increase in the phase noise.

Spurious components separated by multiples of formula (1) deteriorate the performance of an OEO having a single optical fiber. An obvious way to solve the problem is an introduction of an additional fiber loop with a different length. The joint amplification of two signals with different harmonic separations results in an effective filtering of all components except those whose frequencies in each loop are equal. A single loop OEO is described in detail in U.S. Pat. No. 5,723,856 and multi-loop OEOs are presented in U.S. Pat. Nos. 5,777,778, 7,027,675 B2, and 7,151,415 B1. Typically, two-loop OEOs comprises a long fiber providing high value of Q and a short fiber with much larger harmonic separation Df. Dual loop OEOs allow for a single or dual injection locking operation when a portion of the output signal from the master (long) loop oscillator is coupled as an inject lock input signal to a slave (short) loop oscillator as disclosed in U.S. Pat. No. 7,151,415 B1. The slave loop oscillator has lower Q than the master loop. However, the effective total Q of the OEO remains high due to the injection locked high Q signal received by the slave loop from the master oscillator.

Accordingly, there is a need for a dual-loop system that decreases the spurious level of the OEO.

### BRIEF SUMMARY OF THE INVENTION

The present subject matter relates generally to photonic and optoelectronic oscillators of improved performance providing high RF frequency stability and ultralow levels of phase noise. The present disclosure can find application in a wide variety of fields, wherever signal generation is required at high respective frequencies with reduced noise, such as high frequency communication, radars, metrology, navigation, timing, and global position. OEO generated signals may be used as carriers and are important in clock recovery, and in communication broadcasting and receiving.

The present disclosure provides a dual loop self-injection locked optoelectronic oscillator design which uses a single fiber in both loops. By contrast to the previously developed dual loop OEOs, wherein each loop has its own long/short fiber as the energy storage element, the present system exploits just a single fiber for the both loops.

In an example, the proposed OEO comprises a continuous wave laser that generates an optical output signal. The output signal from the laser is coupled as an input to an optical intensity modulator with an electrical bias input and an RF input and an optical output. The output modulated optical signal from the modulator is coupled into a long optical fiber with high Q, the other end of the fiber being connected to an optical coupler/splitter. This fiber plays a role of the energy storage element for both loops of the OEO. One arm of the optical coupler is connected to a photodetector, which converts the modulated optical signal into an RF signal. The portion of light in the other arm of the optical coupler is then coupled to the second photodetector. The second arm of the optical coupler is made intentionally much longer than the first arm. The difference of the arms lengths DL is much smaller than the first fiber length L. The two RF signals detected by the photodetectors are then amplified by low-noise amplifiers and are filtered by two RF bandpass filters. The filtered RF signals are combined by an RF coupler/combiner. The joint RF signal is then split and a portion of the output signal is coupled as a feedback signal to the RF input of the optical modulator, whilst the other portion of the RF signal is the output signal of the OEO.

The present dual loop system decreases the spurious level of the OEO. The spurious harmonics are unwanted harmonics next to the oscillation frequency. A single-loop OEO with a long fiber has large Q but the harmonics separated by Δf are very close in frequency to each other. As a result a number of harmonics are exited in the OEO within the spectral bandwidth of the RF filter. The most powerful harmonic is the oscillation frequency, the rest ones being spurious. In order to decrease the number of spurious harmonics and their amplitude, the second loop, which includes the same fiber but other electronic components, is introduced. The second loop has a different value of Δf because its effective length is different from the first loop. Due to the interaction of the waves in the two loops of the OEO, the oscillation occurs at frequencies which are common to both loops. As a result, the number of spurious and their intensity in a dual-loop OEO are significantly reduced.

In an example, the optoelectronic oscillator system can include a laser which generates an optical output signal, an optical modulator having an optical input which receives the optical output signal from the laser, an RF modulation input and an optical output, a fiber optical circulator connected by one arm to said optical modulator, an optical fiber which optically couples the second arm of said circulator optical output to an input arm of a 4-port fiber optical coupler, wherein two output arms of said optical coupler are connected together, a photodetector having an input and an output, said photodetector operable to convert a portion of modulated optical signal from the fourth arm of said optical coupler at its input to an RF output signal on its output, an RF amplifier connected in series with said photodetector, a bandpass RF filter connected in series with said RF amplifier output signal, said RF filter having a transmission bandwidth less than or equal to said predetermined pass band, the second photodetector having an input and an output, said photodetector operable to convert a modulated optical signal from the third arm of said optical circulator at its input to an RF output signal on its output, the second RF amplifier connected in series with said second photodetector, the second bandpass RF filter connected in series with said second RF amplifier output signal, said RF filter having a transmission bandwidth less than or equal to said predetermined pass band, an RF power coupler/combiner connected to both said RF filters on its input which merges two modulated RF signals on its output, an RF power coupler/splitter connected in series with said RF power coupler/combiner, wherein a portion of said RF output signal from said RF power coupler/splitter is coupled as a feedback signal to said optical modulator's RF modulation input.

In an example, the optoelectronic oscillator system can include a continuous wave laser which generates an optical output signal, an optical modulator having an optical input which receives the optical output signal from the laser, an RF modulation input and a modulated optical output, an optical fiber which optically couples said modulator optical output to a fiber optical splitter/divider having different lengths of two its output fiber arms, a photodetector having an input and an output, said photodetector operable to convert a portion of modulated optical signal from the shorter arm of said optical splitter/divider at its input to an RF output signal on its output, an RF amplifier connected in series with said photodetector, a bandpass RF filter connected in series with said RF amplifier output signal, said RF filter having a transmission bandwidth less than or equal to said predetermined pass band, the second photodetector having an input and an output, said photodetector operable to convert the second portion of modulated optical signal from the longer arm of said optical splitter/divider at its input to an RF output signal on its output, the second RF amplifier connected in series with said second photodetector, the second bandpass RF filter connected in series with said second RF amplifier output signal, said RF filter having a transmission bandwidth less than or equal to said predetermined pass band, an RF power coupler/combiner connected to both said RF filters on its input which merges two modulated RF signals on its output, an RF power coupler/splitter connected in series with said RF power coupler/combiner, wherein a portion of said RF output signal from said RF power coupler/splitter is coupled as a feedback signal to said optical modulator's RF modulation input, an RF power coupler/splitter connected in series with said RF power coupler/combiner, an RF mixer connected by one input to said RF power coupler/splitter and by the second input to an external RF or microwave signal source, a control circuit with said RF mixer output on its input having an output which adjusts the laser wavelength or/and power by changing the laser temperature and/or current.

An advantage of the present system is providing a simplified configuration of the dual-loop OEO with less number of optical and electronic components that provides ultra-low levels of phase noise.

A further advantage of the present system is that only one optical fiber is used in both loops.

Another advantage of the present configuration of the OEO is that the same value of Q can be achieved with an optical fiber of a half length since in an alternative configuration the light travels back and forth in the same optical fiber, ensuring the effective cavity length of the OEO to be twice as much as the physical length of the fiber.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of an example of the system disclosed herein.

FIG. 2A is a spectrum illustrating harmonics of two fiber loops with a small difference in length DL (blue and green lines) and the bandpass filter spectral characteristic (red line). The harmonics of the loops coincide at zero offset. Horizontal axis is the frequency offset from the oscillation frequency.

FIG. 2B is a spectrum of the output signal of the OEO resulted by the combined action of the two fiber loop.

FIG. 3 is a schematic view of an alternative embodiment of the present invention exploiting an optical circulator and a mirror formed by a 3-D optical coupler.

FIG. 4 is a spectrum of the OEO of the system example presented in FIG. 3 showing harmonics of two fiber loops (blue and green lines) and the bandpass filter spectral characteristic (red line). The harmonics of the loops coincide at zero offset. Horizontal axis is the frequency offset from the oscillation frequency.

FIG. 5 is a spectrum of the output signal of the OEO presented in FIG. 3. The spectrum originates from the combined action of the two loops.

FIG. 6 a schematic view of an alternative embodiment of the present invention exploiting an output signal of the OEO with frequency locking to an external RF source and laser control.

FIG. 7 depicts an example of an RF spectrum of the OEO made in accordance with the design presented in FIG. 1.

### DETAILED DESCRIPTION OF THE INVENTION

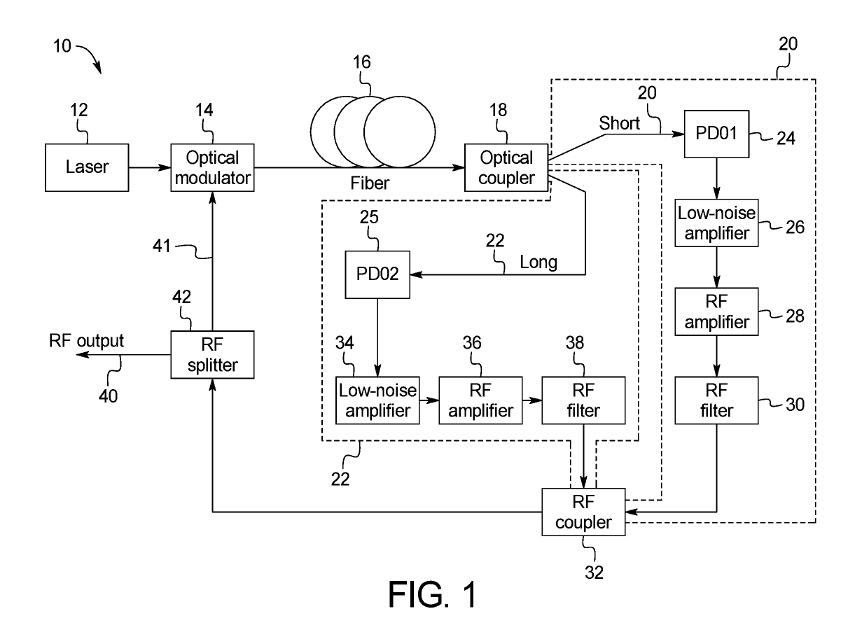

With reference to FIG. 1, an example of the present OEO system 10 includes a continuous wave laser 12 having its output connected as an input signal to an optical modulator 14. Any suitable laser 12 emitting in visible or invisible parts of the spectrum may be used. The optical modulator 14 may be of any conventional construction, such as a Mach-Zehnder modulator or an electro-absorption modulator. A basic feature of the modulator 14 is that it has both DC bias and RF input ports. The output optical signal from the optical modulator is a continuous optical wave modulated at the frequency of the RF signal applied to the modulation port. The output from the optical modulator 14 is coupled to an optical fiber 16 having a high value of Q. The fiber 16 may be a single mode fiber or a multi-mode one. The length of the optical fiber 16 is chosen to ensure the necessary high Q for the oscillator in order to achieve the required phase noise level. In practice, a length of several kilometers of the optical fiber will produce Q values in excess of 10⁸. The fiber 16 is connected to an optical input of an optical coupler/splitter 18 which divides the modulated signal into two parts. The two output arms 20, 22 of the coupler 18 are made intentionally of different lengths. As shown in FIG. 1, the length of short art 22 can have a length of are L and the length of the long arm 22 can have a length of L+DL. The difference in length DL is much smaller than the length of the fiber L. This difference plays an important role in the discrimination of spurious harmonics of the output 40 of the OEO as explained below. The output from a short arm 20 of the coupler is coupled to an optical input of a first photodetector 24. The first photodetector 24 converts one portion of the modulated optical signal on its input to an RF signal on its output. The output from the photodetector is amplified by a first RF amplifier 28 and/or a first microwave low-noise amplifier 26. The output from the first amplifier 26 passes through a first RF bandpass filter 30 to a first RF coupler/combiner 32. The central frequency of the filter fixes the oscillation frequency of the OEO. The transmission bandwidth of the RF filter should be as small as possible for presenting the oscillation of the OEO on a multiple frequencies (harmonics of the fiber loop).

The second longer arm 22 of the optical coupler/splitter 18 is connected to an optical input of the second photodetector 25 which converts the second portion of the modulated optical signal on its input to an RF signal on its output. The modulated RF signal is amplified by a second microwave low-noise amplifier 34, is filtered by a second low-noise amplifier 34 and/or a second RF amplifier 36, a second RF bandpass filter 38 with the same central frequency, and is fed to a first RF coupler/combiner 32. The combined RF signal is then divided by a second RF splitter 42 into two portions. The first portion 41 is coupled to the RF input of the optical modulator 14 and closes the feedback loop of the oscillator. This feedback causes the OEO to oscillate at the desired frequency provided the net gain is larger than the net loss within the loops. The second portion 40 of the RF signal is the output of the OEO 10.

As depicted in FIG. 1, the OEO system 10 consists of two loops having the optical part and the electronic part. The optical part of the first loop includes the optical fiber, the short arm 20 of the optical coupler 18, while the electronic part is the first part of the electronic circuit of the OEO comprising the first photodetector 24, the microwave amplifier 26, 28, and the first RF bandpass filter 30. The second loop includes the optical fiber, the long arm 22 of the optical coupler 18, and the second part of the electronic circuit of the OEO comprising the second photodetector 25, the microwave amplifier 34, 36, and the second RF bandpass filter 38. The lengths of the arms/loops are L and L+DL. For example, the short arm 22 can have a length of are L and the long arm 22 can have a length of L+DL. According to the formulae (1), the separation of the harmonics of the loops is

Δf₁=c/(nL) Δf₂=c/n(L+ΔL) (2)

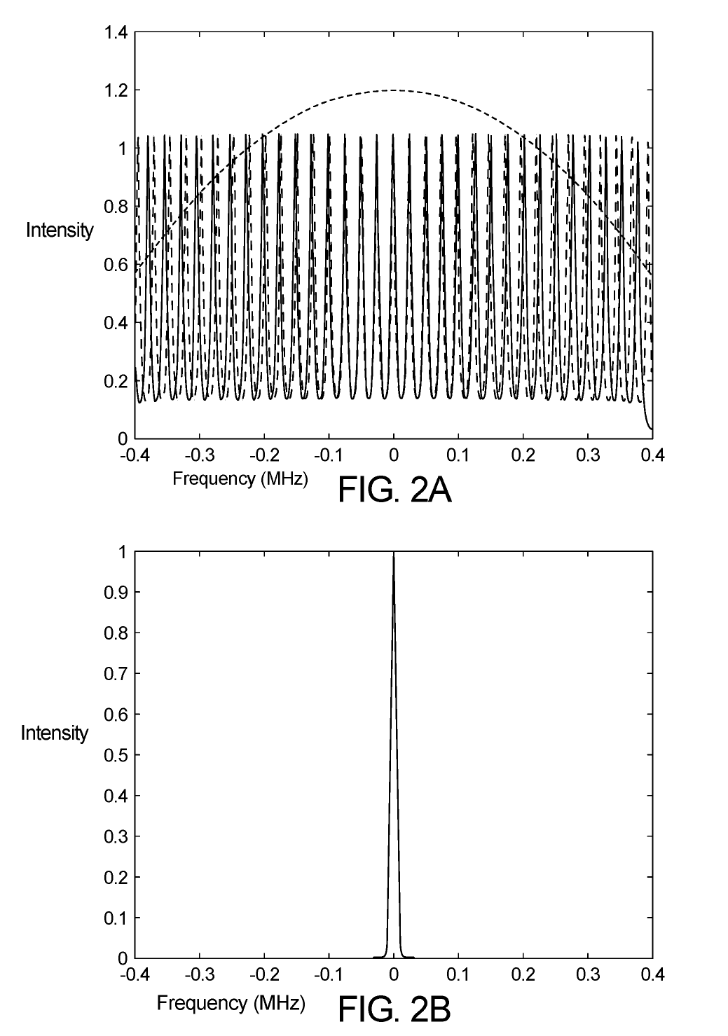

respectively, wherein c is a damping coefficient, n is the number of nodes, and L is the length of the short arm. With reference to FIG. 2A, the spectrum showing harmonics of two fiber loops with a small difference in length DL drawn by the solid and dashed lines. Some harmonics of the two frequency combs coincide at certain frequencies as illustrated at zero frequency offset in FIG. 2A while the rest do not. The transmission peak of the RF filter and its bandwidth as well as the difference DL is chosen to allow just a single frequency to oscillate as shown in FIG. 2B. This frequency corresponds to a frequency which is common to both loops, i.e., the solid line and dashed lines in FIG. 2A overlap completely. Since DL<<L, this condition can be fulfilled for a relatively narrow bandwidth of the RF filter shown in FIG. 2A by the semicircle dotted line. The adjacent harmonics to the central one with a slight frequency mismatch (i.e., the solid and dashed lines do not overlap completely) see much smaller amplification due to the combined action of both loops. These harmonics are observed at the OEO output as spurious frequencies. However, the spurious level can be very small as we demonstrate later.

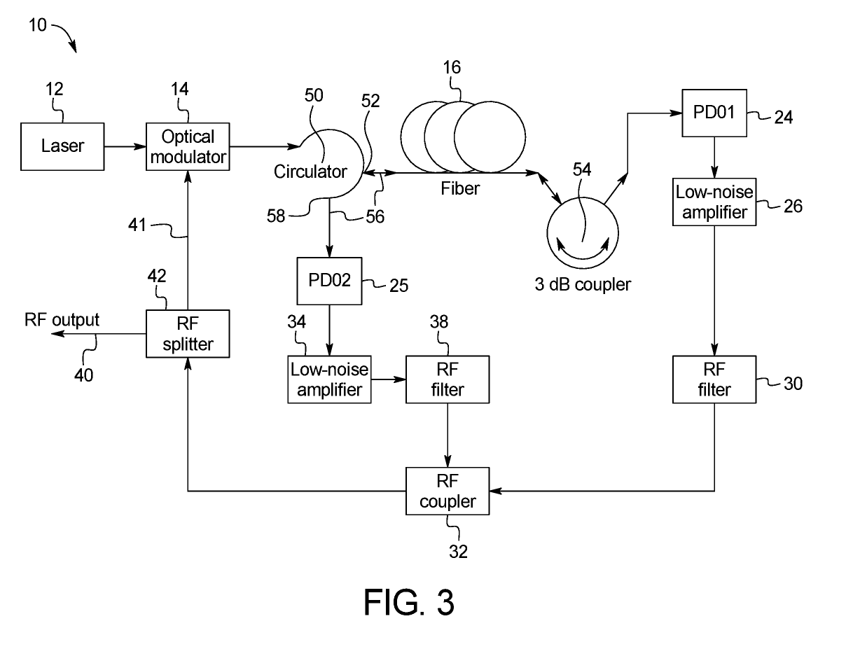

FIG. 3 presents an alternative implementation of a dual loop OEO 10 exploiting just a single optical fiber 16 in both loops. The first two components, the laser 12 and the optical modulator 14, can be the same as in the previous example shown in FIG. 1. The output from the optical modulator is coupled to an optical circulator port 50. The modulated optical signal transmitted through port 52 of the circulator is coupled to an optical fiber 16 having a high value of Q. In a similar manner to foregoing, the fiber 16 may be a single mode fiber or a multi-mode one and its length is chosen to ensure the necessary high Q for the oscillator in order to achieve the required phase noise level. The optical signal transmitted through the fiber 16 is fed into one arm of a 4-port fiber optical splitter/combiner 54. The second arm of the optical splitter/combiner is coupled to an optical input of a photodetector 24. The second arm is made as short as possible. The output from the photodetector 24 is amplified by an RF or microwave low-noise amplifier 26. The output from the amplifier passes through an RF bandpass filter 26 to an RF coupler/combiner 32. The third and fourth arms of the optical splitter/combiner 54 are connected together. This results in the reflection of one part of the modulated optical signal into the second arm of the splitter/combiner and the other part into opposite direction towards the optical circulator port 50. The reflected signal 56 coming from port 50 of the circulator is directed to third port 58. The third port 58 of the optical circulator 50 is connected to an optical input of the second photodetector 25, which converts the second portion of the modulated optical signal on its input to an RF signal on its output. The modulated RF signal is amplified by a second microwave low-noise amplifier 34, is filtered by a second RF bandpass filter 38 with the same central frequency, and is fed to the RF coupler/combiner 32. The combined RF signal is then divided by the second RF splitter 42 into two parts. The first portion 41 is coupled to the RF input of the optical modulator 14 and closes the feedback loop of the oscillator. The second portion 40 of the RF signal is the output of the OEO.

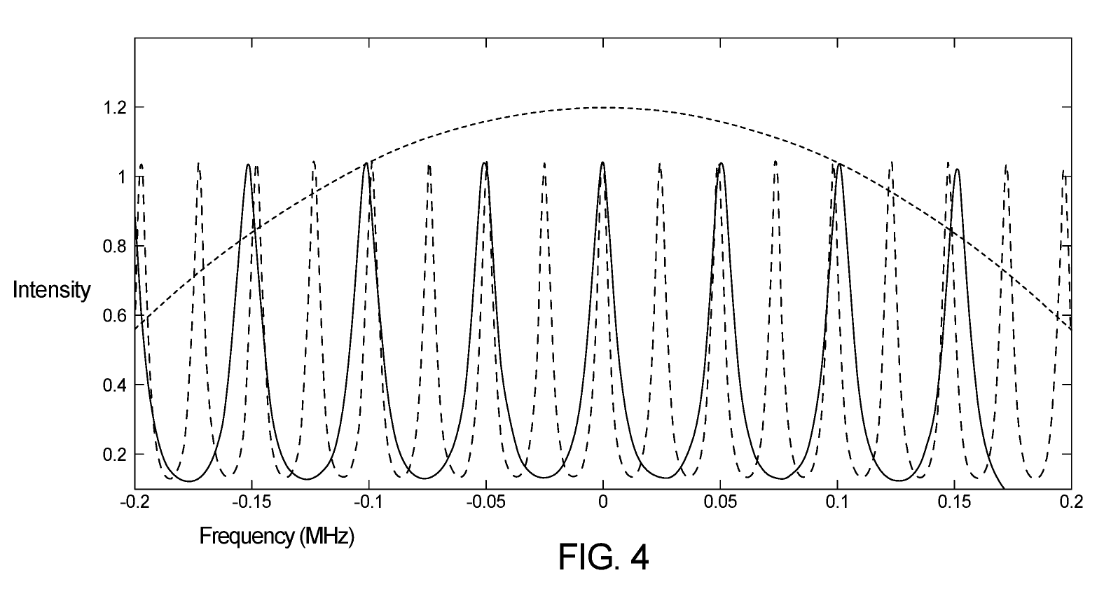

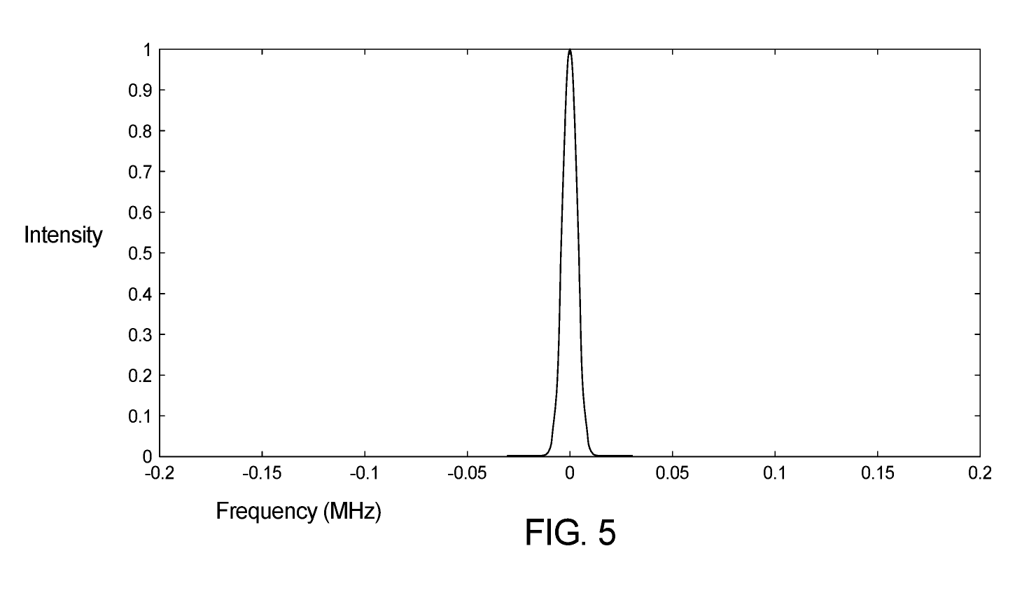

Referring to FIG. 3, the present alternative OEO design consists of two loops with the lengths of L and 2L+DL with DL<<L. FIG. 4 illustrates frequency harmonics of both loops calculated using the formulae (1). In a similar way to above, some harmonics of the two frequency combs (solid and dashed lines) coincide at certain frequencies as illustrated at zero frequency offset in FIG. 2 while the rest do not. The combined action of the two loops results in a preferable amplification of the completely overlapped harmonics at zero frequency offsets, as shown in FIG. 5. The net gain of the dual loop OEO in the largest one for harmonics with equal frequencies in each loop. The adjacent harmonics to the central one with a slight frequency mismatch (the solid and dashed peaks do not overlap completely) undergo much smaller amplification due to the combined action of both loops. These harmonics are observed at the OEO output as spurious frequencies.

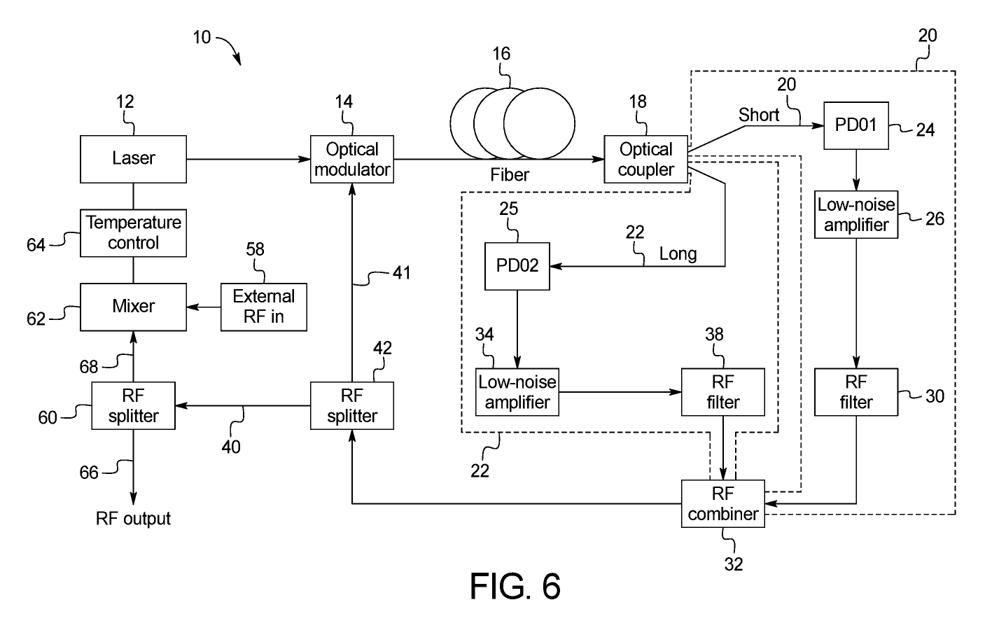

FIG. 6 illustrates an example of the implementation of a dual loop OEO exploiting just a single optical fiber in both loops with the frequency locking to an external source and laser temperature/current control. The example is similar to that of the OEO design presented in FIG. 1 with the inclusion of an additional RF splitter, an RF mixer, and a temperature/current control circuit. An external microwave signal 58 is fed to one arm of the microwave mixer (L port) 62, the other arm (R port) being connected to the third RF splitter 60. The microwave mixer 62 may be a standard single or double balanced one with a DC output at the I port. The low frequency signal from this port, which is proportional to the frequency mismatch of the external source and the OEO, is coupled to the control circuit 64. The circuit 64 adjusts either temperature or current of the laser to minimize the frequency difference between the external source and the oscillating signal of the OEO. This results in an effective locking of the OEO to the stable external source of the microwave signal and eliminating possible drift and temperature fluctuations of the oscillation frequency.

The block diagram of the OEO of a dual loop OEO exploiting just a single optical fiber in both loops is illustrated in FIG. 1. A 1550 nm CW DFB (continuous wave distributed feedback) laser with the relative intensity noise parameter of below −160 dB/Hz is used as the light source. An intensity Mach-Zehnder modulator has a 3-dB bandwidth of above 12 GHz. The standard single mode optical fiber has a length of about 9 km. Two high-speed p-i-n photodetectors have a responsivity of above 0.92 A/W and a 3-dB bandwidth of above 19 GHz. The detected modulated signals in both loops are amplified by two very low noise microwave amplifiers with a noise figure of around 0.7. Two identical RF filters having the peak transmission at 10 GHz and a 3-dB bandwidth of below 4 MHz are used in the OEO loops for filtering out unwanted frequency harmonics.

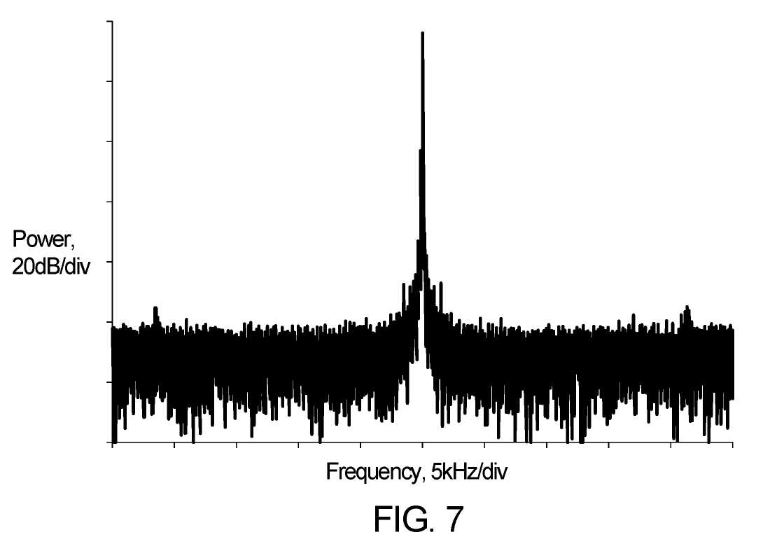

The experimental RF spectrum of the OEO is shown in FIG. 7. The RF power of the oscillation frequency centered at 9.9998 GHz is just under 17 dBm. The accurate measurement of the RF spectrum demonstrates the spurious level to be below −92 dB. The phase noise of the experimental OEO is so low that it was impossible to measure it with the use of standard spectrum analyzers. A special technique for phase noise measurements has been exploited [8,9]. The measured phase noise of the OEO is −122 dBc/Hz and −143 dBc/Hz at 1 kHz and 10 kHz frequency offsets, respectively.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

### REFERENCES

[1] A. Neyer and E. Voges, “High-frequency electro-optic oscillator using an integrated interferometer,” AppL Phys. Lett., vol. 40, pp. 6-8, 1982.
[2] M. F. Lewis, “Novel RF oscillator using optical components,” Electron. Lett., vol. 28, pp. 31-32, 1992.
[3] X. S. Yao and L. Maleki, “Optoelectronic microwave oscillator,” J. Opt. Soc. Amer. B, vol. 13, no. 8, pp. 1725-1735, 1996.
[4] W. Zhou et al, “Potentials and challenges for optoelectronic oscillator”, Proc. SPIE, vol. 8255, 82551, 2012.
[5] O. Okusaga, E. J. Adles, W. Zhou, E. C. Levy, M. Horowitz, C. R. Menyuk, and G. M. Carter, “Spurious mode reduction in dual injection-locked optoelectronic oscillators”, Optics Express, vol. 19, pp. 5839-5854, 2011.
[6] D. Strekalov et al, “Stabilizing an optoelectronic microwave oscillator with photonic filters”, J. Lightwave Tech., vol. 21, pp. 3052-3061, 2003.
[7] K. Volyanskiy, Y. K. Chembo, L. Larger, E. Rubiola, “Contribution of Laser Frequency and Power Fluctuations to the Microwave Phase Noise of Optoelectronic Oscillators”, IEEE J. Lightwave Tech., vol. 28, pp. 2730-2735, 2010.
[8] E. Rubiola et al, “Photonic-delay technique for phase-noise measurement of microwave oscillators,” J. Opt. Soc. Am. B, vol. 22, pp. 987-997, 2005.
[9] Phase noise characterisation of microwave oscillators, Hewlett Packard product note 11729C-2.

We claim:

1. A dual loop optoelectronic oscillation circuit for sustaining a microwave signal, the circuit comprising:
a continuous wave laser;
an optical modulator including a modulated optical output, wherein the optical modulator receives an optical output signal from the continuous wave laser, wherein the optical modulator receives an RF modulation input;
an optical fiber connecting the optical modulator to a fiber optical splitter, wherein a short arm and a long arm exit the fiber optical splitter, wherein the length of the short arm is less than the length of the long arm,
wherein the short arm includes a first photodetector connected in series with the optical splitter, a first RF amplifier connected in series with the first photodetector, a first bandpass RF filter connected in series with the first RF amplifier, and an RF power coupler connected in series to the first RF filter,
wherein the RF power coupler generates a modulated output signal from the RF signals from the first RF filter and the second RF filter,
wherein the first photodetector converts a first portion of modulated optical signal from the optical splitter to a first RF output signal,
wherein the long arm includes a second photodetector connected in series with the optical splitter, a second RF amplifier connected in series with the second photodetector, a second bandpass RF filter connected in series with the second RF amplifier output signal, and the RF power coupler connected in series to the first RF filter,
wherein the second photodetector converts a second portion of modulated optical signal from the optical splitter to a second RF output signal; and
an RF power splitter connected in series with the RF power coupler, wherein a first portion of the RF output signal from the RF power splitter is input into the optical modulator, wherein a second portion of the RF output signal from the RF power splitter is a first final RF output signal.

2. The circuit of claim 1, further comprising
a second RF splitter to receive the final RF output signal from the RF power splitter, wherein the second RF splitter divides the first final RF output into a second final RF output and a second RF output portion; and
a mixer connected in series with the second RF splitter, wherein the mixer receives the second RF output portion from the second RF splitter.

3. The circuit of claim 2, further comprising a temperature control unit connected in series with the mixer, wherein the temperature control unit adjusts the temperature of the output of the mixer.

4. The circuit of claim 1, wherein the mixer receives an external RF input.

5. The circuit of claim 1, wherein the laser is a continuous wave distributed feedback laser.

6. The circuit of claim 1, wherein the optical modulator includes DC bias and RF input ports.

7. The circuit of claim 1, wherein the difference in length between the short arm and the long arm is less than the length of the short arm.

8. The circuit of claim 1, wherein the first RF filter includes a transmission bandwidth less than or equal to a predetermined pass band, wherein the second RF filter includes a transmission bandwidth less than or equal to the predetermined pass band.

9. The circuit of claim 1, wherein the first RF filter and the second RF filter each include a peak transmission at 10 GHz and 3-dB bandwidth less than 4 MHz.

10. The circuit of claim 1, wherein the short arm and the long arm are a single fiber.

11. A dual loop optoelectronic oscillation circuit for sustaining a microwave signal, the circuit comprising:
a continuous wave laser;
an optical modulator including a modulated optical output, wherein the optical modulator receives an optical output signal from the continuous wave laser, wherein the optical modulator receives an RF modulation input;
an optical fiber connecting the optical modulator to an optical circulator, wherein a first output fiber and a second output exit the optical circulator;
a 4-port fiber optical splitter receiving the first output fiber, wherein the 4-port fiber optical splitter divides the first output fiber into a first output portion of the 4-port fiber optical splitter in a short arm and a second output portion of the 4-port fiber optical splitter in a long arm,
wherein the short arm includes a first photodetector connected in series with the 4-port fiber optical splitter, a first RF amplifier connected in series with the first photodetector, a first bandpass RF filter connected in series with the first RF amplifier, and an RF power coupler connected in series to the first RF filter,
wherein the second portion of the output from the 4-port fiber optical splitter is reflected back to the optical circulator, wherein the long arm includes a second photodetector connected in series with the optical circulator, a second RF amplifier connected in series with the second photodetector, a second bandpass RF filter connected in series with the second RF amplifier, and the RF power coupler is connected in series to the second RF filter,
wherein the RF power coupler generates a modulated output signal from the RF signals from the first RF filter and the second RF filter; and
an RF power splitter connected in series with said RF power coupler, wherein a first portion of the RF output signal from the RF power splitter is input into the optical modulator, wherein a second portion of the RF output signal from the RF power splitter is a final RF output signal.

12. The circuit of claim 11, wherein the laser is a continuous wave distributed feedback laser.

13. The circuit of claim 11, wherein the optical modulator includes DC bias and RF input ports.

14. The circuit of claim 11, wherein the difference in length between the short arm and the long arm from the optical splitter is less than the length of the optical fiber.

15. The circuit of claim 11, wherein the first RF filter includes a transmission bandwidth less than or equal to a predetermined pass band, wherein the second RF filter includes a transmission bandwidth less than or equal to the predetermined pass band.

16. The circuit of claim 11, wherein the first RF filter and the second RF filter each include a peak transmission at 10 GHz and 3-dB bandwidth less than 4 MHz.

17. The circuit of claim 11, wherein the short arm and the long arm are a single fiber.
